(19) United States
(12) Patent Application Publication
(10) Pub. No.: US 2008/0011193 A1
(43) Pub. Date: Jan. 17, 2008

(54) Water-bsed pigment dispersion, water-based ink, and ink jet recording liquid

(75) Inventor: William Marritt, Hauula, HI (US)

Correspondence Address: LADAS & PARRY, 26 WEST 61ST STREET, NEW YORK, NY, 10023, US

(73) Assignee: SEIKO EPSON CORPORATION

(21) Appl. No.: 11/725,980

(22) Filed: Mar. 20, 2007

(30) Foreign Application Priority Data
Mar. 22, 2006 (JP) 2006-078250

(51) Int. Cl. C09D 11/02; C08K 5/04

(52) U.S. Cl. 106/31.89; 106/503

(57) ABSTRACT

[Object] To provide a water-based pigment dispersion having superior ejection stability, long-term storage stability and clogging resistance. [Solving Means] A water-based pigment dispersion comprising: a pigment dispersoid containing a pigment and a sulfonate-based polymerizable surfactant adsorbed to the pigment, wherein the water-based pigment dispersion is produced by a process including the steps of: pulverizing and mixing a mixture containing the pigment, the sulfonate-based polymerizable surfactant, and an aqueous medium to prepare a water-based dispersion; treating the water-based dispersion in the presence of a peroxodisulfate to prepare a modified water-based dispersion; and subjecting the modified water-based dispersion to ultrafiltration until the dissolved portion of the sulfonate-based polymerizable surfactant in the aqueous medium is reduced to less than 10 ppm.

### TECHNICAL FIELD

The present invention relates to a water-based pigment dispersion, a water-based ink, and an ink jet recording liquid.

### BACKGROUND ART

Recent recording apparatuses such as ink jet recording apparatuses have mainly used water-based ink. Water-based pigment inks are coming on the market one after another because of their fastness. Such water-based pigment inks are required to be ejected stably through nozzles of the printer head (to have ejection stability). In addition, it is important that ink is stably stored in the printer head for a long term. In order to ensure ejection stability and long-term storage stability, it is desired that components of the water-based pigment ink be well dispersed with a certain viscosity.

The most important part of the water-based pigment ink is the original water-based pigment dispersion. It is well known that even if a so-called “stabilizer” is added, water ink does not become stable unless the water-based pigment dispersion constituting the water-based ink is stable. It is also well known that in order to design a water-based ink arbitrarily for an object to be printed, components ineffective for the desired ink composition (undesired components or portion) should not be contained in the original water-based pigment dispersion. For example, if a glossy print is desired, it is preferable that the water-based pigment dispersion do not contain components not contributing to the glossiness. In other words, it is desired that the water-based pigment dispersion contain only a stable pigment dispersoid (pigment to which dispersant has been adsorbed) and an aqueous medium (mainly containing water).

In order to disperse a pigment in an aqueous medium stably, a polymer material, a surfactant, or the like is generally used as a dispersant. If the dispersant is dissolved in the aqueous medium, a portion of the dispersant adsorbed to the pigment and the other portion, which is dissolved in the aqueous medium, are present in equilibrium. If the portion of the dispersant dissolved in the aqueous medium is selectively removed, the dispersant adsorbed to the pigment desorbs from the pigment and transfers to the aqueous medium as the dissolved portion is reduced. When a certain amount or more of dispersant is desorbed, the stability of the pigment in the dispersion is significantly degraded. If the dispersant is not dissolved in the aqueous medium, the portion of the dispersant adsorbed to the pigment and the portion insoluble in the aqueous medium are present independently. It is well known that the insoluble portion of the dispersant cannot be selectively removed by common methods, such as ultrafiltration and centrifugation, because the particle size and density of the dispersant are almost the same as those of the pigment dispersoid. In general, the insoluble portion is not effective for the resulting ink composition. Hence, if the dispersant is not dissolved in the aqueous medium, the water-based ink cannot be arbitrarily designed for an object to be printed.

Some inks have been proposed which use a self-dispersing pigment dispersion containing a surface-treated pigment to enhance the ejection stability, long-term storage stability, and ink design flexibility. For example, Japanese Unexamined Patent Application Publication Nos. 8-319444 and 11-323232 have disclosed inks prepared from a self-dispersing pigment dispersion containing a pigment constituted of particles whose surfaces are oxidized (Patent Documents 1 and 2). Also, a self-dispersing pigment dispersion is often used as the original pigment dispersion for an ink composition, depending on the application or the intended ink composition (Patent Documents 3 and 4). A water-based paint composition, but not a self -dispersing pigment, containing a polymerizable surfactant and a peroxodisulfate has been known (Patent Document 5).

[Patent Document 1] Japanese Unexamined Patent Application Publication No. 8-319444

[Patent Document 2] Japanese Unexamined Patent Application Publication No. 11-323232

[Patent Document 3] Japanese Unexamined Patent Application Publication No. 2000-313830

[Patent Document 4] Japanese Unexamined Patent Application Publication No. 2001-302951

[Patent Document 5] Japanese Unexamined Patent Application Publication No. 2004-292686

### DISCLOSURE OF THE INVENTION

### Problems to be Solved by the Invention

It is however being required that ink compositions have much superior ejection stability, long-term storage stability, and ink design flexibility to meet the demand for higher quality images. Although self-dispersing pigment dispersions using a surface-treated pigment have been well known, molecules to which a hydrophilic functional group has been introduced are desorbed from the pigment particles, and thus inks other than inks using carbon black (for black ink), particularly inks using organic color pigments (for color inks), have not yet exhibited sufficient ejection stability or long-term storage stability. This is because organic color pigments are constituted of discrete particles separate from each other, unlike carbon black, whose molecules are continued. A water-based pigment dispersion containing only stable pigment particles, but not containing undesired dispersant has not yet been known except for dispersions containing surface-treated self-dispersing pigment.

Accordingly, an object of the invention is to provide a water-based pigment dispersion, a water-based ink and an ink jet recording liquid that have superior ejection stability, long-term storage stability, and ink design flexibility.

### Means for Solving the Problems

The inventors of the invention have studied about various sulfonate-based polymerizable surfactants, water-based dispersions containing a sulfonate-based polymerizable surfactant and a pigment, and treatment of the water-based dispersion with an additive. As a result, the inventors have found that the sulfonate-based polymerizable surfactant of a water-based dispersion modified by treatment in the presence of a peroxodisulfate can have an extremely higher adsorption power to the pigment than the sulfonate-based polymerizable surfactant of an untreated water-based dispersion. The inventors have further studied about treating the modified water-based dispersion by ultrafiltration until the dissolved portion of the sulfonate-based polymerizable surfactant in an aqueous medium is reduced to a significantly low concentration. As a result, the inventors have found that when the dissolved portion of the sulfonate-based polymerizable surfactant in the aqueous medium is reduced to less than 10 ppm, the ink design flexibility is dramatically increased to give superior ejection stability and long-term storage stability to a water-based ink. Thus, the inventors completed the invention, and the invention can solve the above-described disadvantages according to the following description. In the invention, a preferred form of the water-based pigment dispersion is an ink jet recording liquid.

According to the invention, a water-based pigment dispersion is provided which contains a pigment dispersoid containing a pigment and a sulfonate-based polymerizable surfactant adsorbed to the pigment. The water-based pigment dispersion is produced by a process including the steps of: pulverizing and mixing a mixture containing the pigment, the sulfonate-based polymerizable surfactant, and an aqueous medium to prepare a water-based dispersion; treating the water-based dispersion in the presence of a peroxodisulfate to prepare a modified water-based dispersion; and subjecting the modified water-based dispersion to ultrafiltration until the dissolved portion of the sulfonate-based polymerizable surfactant in the aqueous medium is reduced to less than 10 ppm.

The above process provides a water-based pigment dispersion not containing the undesired portion of the sulfonate-based polymerizable surfactant, but containing a pigment dispersoid in which the adsorption of sulfonate-based polymerizable surfactant to the pigment has been enhanced.

The sulfonate-based polymerizable surfactant may be a compound expressed by general formula (1):

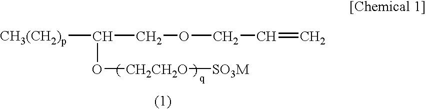

(In the above formula, p represents a number of 9 or 11, q represents a number in the range of 2 to 20, and M represents an alkali metal atom, ammonium, or protonated alkanolamine.

The compound expressed by general formula (1) may be a mixture of a compound having p of 9, q of 10, and M of ammonium and a compound having p of 11, q of 10, and M of ammonium.

The peroxodisulfate may be selected from the group consisting of sodium peroxodisulfate, potassium peroxodisulfate, and ammonium peroxodisulfate.

The sulfur content of the sulfonate-based polymerizable surfactant adsorbed to the pigment may be at least 15% higher than that in an untreated water-based pigment dispersion obtained by ultrafiltration performed until the dissolved portion of the sulfonate-based polymerizable surfactant in the aqueous medium is reduced to less than 10 ppm without treating the water-based dispersion with the peroxodisulfate.

The pigment may have an average particle size of 100 nm or less.

The invention also provides a water-based ink containing the foregoing water-based pigment dispersion as an original pigment dispersion. The invention also provides an ink jet recording liquid containing the foregoing water-based pigment dispersion as an original pigment dispersion.

### BEST MODE FOR CARRYING OUT THE INVENTION

A water-based pigment dispersion of the invention contains a pigment dispersoid containing a pigment and a sulfonate-based polymerizable surfactant adsorbed to the pigment. The water-based pigment dispersion is produced through the steps of: pulverizing and mixing a mixture of the pigment, the sulfonate-based polymerizable surfactant and an aqueous medium to prepare a water-based dispersion; treating the water-based dispersion in the presence of a peroxodisulfate to prepare a modified water-based dispersion; and ultrafiltering the modified water-based dispersion until the dissolved portion of the sulfonate-based polymerizable surfactant in the aqueous medium is reduced to less than 10 ppm.

The essential components of the water-based pigment dispersion according to the invention will now be described, followed by describing other components. Then, the water-based ink and ink jet recording liquid containing the water-based pigment dispersion will be described. In the following description, “%” means percent by weight; “part(s)” means part(s) by weight; “ratio” is on a weight basis; and “ppm” means 1 part by weight relative to 1000,000 parts by weight, unless otherwise specified.

(Water-Based Pigment Dispersion)

(Pigment)

Both inorganic pigments and organic pigments can be used as the pigment in the invention without particular limitation. Examples of the inorganic pigments include metals, such as copper oxide, iron oxide, titanium oxide; and carbon blacks, such as furnace black, lampblack, acetylene black, and channel black. Examples of the organic pigments include azo pigments (including azo lake, insoluble azo pigments, condensed azo pigments, and chelate azo pigments); polycyclic pigments (phthalocyanine, perylene, perinone, anthraquinone, quinacridone, dioxane pigments, thioindigo, isoindolinone, quinofuranone, etc.); dye chelates (basic dye chelates, acid dye chelates, etc.); nitro pigments; nitroso pigments; and aniline black.

Exemplary pigments for black ink include C. I. Pigment Black 11 being an iron oxide, C. I. Pigment Black 7 being a carbon black, and C. I. Pigment Black 1 being an aniline black. More specifically, the following carbon blacks may be used: No. 2300, No. 900, MCF88, No. 33, No. 40, No. 45, No. 52, MA7, MA8, MA100, No2200B, etc. produced by Mitsubishi Chemical; Raven 5750, Raven 5250, Raven 5000, Raven 3500, Raven 1255, Raven 700, etc. produced by Columbia Chemicals; Regal 400R, Regal 330R, Regal 1660R, Mogul L, Monarch 700, Monarch 800, Monarch 880, Monarch 900, Monarch 1000, Monarch 1100, Monarch 1300, Monarch 1400, etc. produced by Cabot; and Color Black FW1, Color Black FW2, Color Black FW2V, Color Black FW18, Color Black FW200, Color Black S150, Color Black S160, Color Black S170, Printex 35, Printex U, Printex V, Printex 140U, Special Black 6, Special Black 5, Special Black 4A, Special Black 4, etc. produced by Degussa.

Exemplary pigments for yellow ink include C. I. Pigment Yellows 1 (Fast Yellow G), 2, 3, 12 (Disazo Yellow AAA), 13, 14, 16, 17, 24, 34, 35, 37, 42 (yellow iron oxide), 53, 55, 73, 74, 75, 81, 83 (Disazo Yellow HR), 93, 95, 97, 98, 100, 101, 104, 108, 109, 110, 114, 117, 120, 128, 129, 138, 151, 153, and 154. Exemplary pigments for magenta ink include C. I. Pigment Reds 1, 2, 3, 5, 7, 12, 17, 22 (brilliant fast scarlet), 23, 31, 38, 48 (Ca), 48 (Mn), 48:2 (Permanent Red 2B (Ba)), 48:2 (Permanent Red 2B (Ca)), 48:3 (Permanent Red 2B (Sr)), 48:4 (Permanent Red 2B (Mn)), 49:1, 52:2, 53:1, 57 (Ca), 57:1 (Brilliant Carmine 6B), 60:1, 63:1, 63:2, 64:1, 81 (Rhodamine 6G Lake), 83, 88, 101 (red iron oxide), 104, 105, 106, 108 (cadmium red), 112, 114, 122 (quinacridone magenta), 123, 146, 149, 166, 168, 170, 172, 177, 178, 179, 184, 185, 190, 193, 202, 209, 219, and C. I. Pigment Violet 19. Exemplary pigments for cyan ink include C. I. Pigment Blues 1, 2, 3, 15 (Phthalocyanine Blue R), 15:1, 15:2, 15:3 (Phthalocyanine Blue G), 15:4, 15:6 (Phthalocyanine Blue E), 15:34, 16, 17:1, 22, 56, 60, 63, and C. I. Vat Blue 4, C. I. Vat Blue 60. Exemplary pigments for green ink include C. I. Pigment Greens 1, 4, 7, 8, 10, 17, 18, and 36. Preferably, the pigment has, but not limited to, a particle size of 1.0 μm or less, and more preferably 0.5 μm or less before preparing the dispersion by pulverizing and mixing. For preparing the water-based dispersion by pulverizing and mixing a pigment, a sulfonate-based polymerizable surfactant, and an aqueous medium, the pigment content is preferably in the range of 1% to 30%, and more preferably in the range of 1% to 20%.

(Sulfonate-Based Polymerizable Surfactant)

The sulfonate-based polymerizable surfactant of the invention is not particularly limited and has a sulfonic group, a hydrophobic group, and a polymerizable group. The sulfonic group preferably forms a salt, such as an alkali metal salt, ammonium salt, or an alkanolamine salt (protonated alkanolamine). Alkali metal salts include those of lithium, sodium, potassium, and cesium.

The hydrophobic group is preferably at least one group selected from among alkyl groups having a carbon number of 8 to 16 and aryl groups, such as phenyl and phenylene. The molecule of the surfactant may have both an alkyl group and an aryl group.

The polymerizable group is preferably an unsaturated hydrocarbon group capable of radical polymerization, such as vinyl, allyl, acryloyl, methacryloyl, propenyl, vinylidene, or vinylene. Among these particularly preferred are allyl, methacryloyl, and acryloyl.

For example, sulfonic allyl derivatives disclosed in Japanese Examined Patent Application Publication Nos. 49-46291 and 1-24142 and Japanese Unexamined Patent Application Publication No. 62-104802 may be used as the sulfonate-based polymerizable surfactant.

Preferably, such a sulfonate-based polymerizable surfactant is expressed by the following general formula (1): 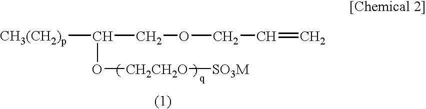
(In the above formula, p represents a number of 9 or 11, q represents a number of 2 to 20, and M represents an alkali metal atom, ammonium, or protonated alkanolamine.)

More preferably, the compound expressed by general formula (1) is a mixture of a compound having p of 9, q of 10, and M of ammonium and a compound having p of 11, q of 10, and M of ammonium. The sulfonate-based polymerizable surfactant may be a commercially available compound, such as AQUALON KH series (AQUALON KH-5 and AQUALON KH-10) (product names) produced by Dai-ichi Kogyo Seiyaku. AQUALON KH-5 is a mixture of compounds expressed by general formula (1) having p of 9 and q of 5 and having p of 11 and q of 5. AQUALON KH-10 is a mixture of compounds expressed by general formula (1) having p of 9 and q of 10 and having p of 11 and q of 10.

The sulfonate-based polymerizable surfactant may be a compound expressed by the following general formula (2): 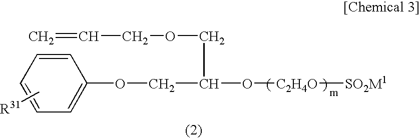
(In the formula, R³¹ represents hydrogen or a hydrocarbon group having a carbon number of 1 to 12, m represents an integer of 2 to 20, M¹ represents an alkali metal, ammonium, or protonated alkanolamine.)

This type of sulfonate-based polymerizable surfactant may be a commercially available compound. For example, ADEKA REASOAP SE-10N produced by Asahi Denka is a compound expressed by general formula (2) having NH₄ as M¹, C₉H₁₉ as R³¹, and m of 10. ADEKA REASOAP SE-20N produced by Asahi Denka is a compound expressed by general formula (2) having NH₄ as M¹, C₉H₁₉ as R³¹, and m of 20.

The sulfonate-based polymerizable surfactant may be a compound expressed by general formula (3). 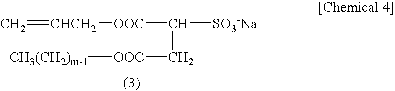
(In the above formula, m represents 12 or 16.)

This type of sulfonate-based polymerizable surfactant may be a commercially available compound, such as ELEMINOL JS-2 produced by Sanyo Chemical Industries. ELEMINOL JS-2 is a compound expressed by general formula (3) with m of 12.

The sulfonate-based polymerizable surfactant may be a compound expressed by general formula (4): 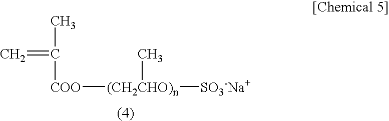
(In the above formula, n represents a number of 1 to 20.)

This type of sulfonate-based polymerizable surfactant may be a commercially available compound, such as ELEMINOL RS-30 produced by Sanyo Chemical Industries. ELEMINOL RS-30 is a compound expressed by general formula (4) with n of 9.

The above-cited sulfonate-based polymerizable surfactants may be used singly or in combination.

(Aqueous Medium)

The aqueous medium used in the invention essentially composed of water. Most preferably, the aqueous medium does not contain any solvent, such as a water-soluble organic solvent, or a water-soluble salt, except water (hence, the aqueous medium is composed of 100% of water). The water can be pure water or ultrapure water, such as ion exchange water, ultrafiltered water, reverse osmotic water, or distilled water, from the view point of reducing ionic impurities as much as possible. The aqueous medium may contain a small amount of water-soluble organic solvent as long as the water-based dispersion containing a pigment, a sulfonate-based polymerizable surfactant and the aqueous medium is not negatively affected. Examples of such water-soluble organic solvent include: (1) alcoholic organic solvents, such as isopropyl alcohol and butyl alcohol; (2) ketonic organic solvents, such as acetone and methyl ethyl ketone; (3) ethereal organic solvents, such as tetrahydrofuran and dioxane; (4) ester solvents, such as ethyl acetate and propylene carbonate; (5) nitrogen-containing organic solvents, such as urea, pyrrolidone, and N-methyl-2-pyrrolidone; and (6) sulfur-containing organic solvents, such as dimethyl sulfoxide and tetramethylene sulfoxide. The aqueous medium may contain additives, such as a pH adjuster, an antiseptic, and an antioxidant, if necessary. The total amount of the additives may be set as required, but preferably the water content in the resulting aqueous medium is 90% or more, and more preferably 95% or more.

(Preparation of Aqueous Water-Based Dispersion)

The aqueous water-based pigment dispersion of the invention is prepared through three steps. First, a water-based dispersion is prepared. More specifically, a pigment, a sulfonate-based polymerizable surfactant, and an aqueous medium are pulverized and mixed to yield the water-based dispersion. In the mixture before pulverizing and mixing, in the invention, the ratio of the pigment to the sulfonate-based polymerizable surfactant is preferably 5:1 to 1:10, and more preferably 4:1 to 1:3. Also, the ratio of the aqueous medium to the solid content (pigment and sulfonate-based polymerizable surfactant) is preferably 50:1 to 1:1, and more preferably 20:1 to 2:1, in the mixture before pulverizing and mixing. For example, a water-based dispersion having a uniform particle size of 100 nm or less can be prepared in the step of pulverizing and mixing, using a disperser, such as a ball mill, a sand mill, an attritor, a roll mill, an agitator mill, a Henschel mixer, a colloid mill, an ultrasonic homogenizer, a Jet mill, or an angmill. Before charging the disperser, a mixer for premixing may b used. Preferably, for the preparation of the water-based dispersion, the average particle size of the dispersoid (pigment to which the sulfonate-based polymerizable surfactant has been adsorbed) measured by dynamic light scattering is 100 nm or less, and more preferably 80 nm or less. For the following step, the aqueous water-based dispersion may be used as it is, or may be subjected to centrifugation, pressure filtration, vacuum filtration, or the like to remove a small amount of coarse particles.

(Peroxodisulfate)

As mentioned above, the water-based pigment dispersion is produced through three steps, and the second step prepares a modified aqueous water-based dispersion. More specifically, the modified water-based dispersion is prepared by treating the water-based dispersion in the presence of a peroxodisulfate. The peroxodisulfate can be at least one selected from the group consisting of sodium peroxodisulfate, potassium peroxodisulfate, and ammonium peroxodisulfate. Preferably, the cation of the peroxodisulfate is the same as the cation of the sulfonate-based polymerizable surfactant. The ratio of the peroxodisulfate to the sulfonate-based polymerizable surfactant (portion contained in the water-based dispersion) is preferably 2:1 to 1:100, and more preferably 1:1 to 1:50.

(Preparation of Modified Aqueous Water-Based Dispersion)

As mentioned above, the modified aqueous water-based dispersion is prepared by the second step. The water-based dispersion is treated in the presence of a peroxodisulfate to prepare the modified water-based dispersion. For this treatment, first a peroxodisulfate and/or a solution of peroxodisulfate are added to the water-based dispersion. Then, the mixture is heated with stirring to at least a temperature at which the peroxodisulfate is decomposed. Preferably, the mixture is heated to a temperature of 50 to 100° C., and more preferably 60 to 90° C. The heating time is preferably 0.5 to 10 hours, and more preferably 1 to 5 hours. For the preparation of the modified water-based dispersion, the average particle size of the dispersoid treated in the presence of the peroxodisulfate measured by dynamic light scattering is preferably 100 nm or less, and more preferably 80 nm or less, as in the original water-based dispersion. For the following step, the modified water-based dispersion may be used as it is, or may be subjected to centrifugation, pressure filtration, vacuum filtration, or the like to remove a small amount of undesired coarse particles.

(Preparation of Water-Based Pigment Dispersion)

As mentioned above, the water-based pigment dispersion is produced through three steps, and the third step prepares the water-based pigment dispersion. More specifically, the water-based pigment dispersion is prepared by ultrafiltering the modified water-based dispersion until the dissolved portion of the sulfonate-based polymerizable surfactant in the aqueous medium is reduced to less than 10 ppm. Thus, the water-based pigment dispersion not containing undesired portion of the sulfonate-based polymerizable surfactant is prepared. In order to remove the sulfonate-based polymerizable surfactant from the aqueous medium in the invention, a separation technique can be applied, such as ultrafiltration, dialysis, microfiltration, nanofiltration, or electrodialysis. Preferably, ultrafiltration is applied. For selecting a membrane for ultrafiltration, it is the most important that while the sulfonate-based polymerizable surfactant can pass through the pores of the membrane, the dispersoid (pigment to which the sulfonate-based polymerizable surfactant has been adsorbed) cannot pass through the pores. The average pore size of ultrafiltration membranes is commonly represented by the average molecular weight of high molecular weight molecules. In the invention, the ultrafiltration membrane preferably has an average pore size of 20 to 1,000 kilodaltons, and more preferably of 50 to 500 kilodaltons, from the viewpoint of removing the sulfonate-based polymerizable surfactant from the aqueous medium. In general, ultrafiltration is performed by adding water the liquid to be filtrated while the filtrate is collected. In the invention, the ultrafiltration is preferably performed by adding water and/or alkalescence water. It is important in the invention that ultrafiltration is performed until the portion dissolved in the aqueous medium of the sulfonate-based polymerizable surfactant is reduced to less than 10 ppm in the pigment dispersion. Whether or not the dissolved portion is less than 10 ppm can be checked by measuring the portion being the sulfonate-based polymerizable surfactant solution in the dispersion. For this measurement, an aliquot of the dispersion is subjected to ultra-centrifugation, and the resulting supernatant of the aqueous medium is sampled and analyzed. In this instance, the analysis is performed by measuring refraction. More specifically, pure water as a reference and a standard solution containing the sulfonate-based polymerizable surfactant are measured with a refractive index detector connected to a high-performance liquid chromatography apparatus. The sensitivity of this method is generally about 0.5 ppm. While the ultrafiltration and the measurement of the dissolved portion are mainly performed on the water-based pigment dispersion, they must be performed on an untreated water-based dispersion for comparison in the same manner in order to measure the content of sulfur of the sulfonate-based polymerizable surfactant adsorbed to the pigment by the treatment with a peroxodisulfate. It is therefore necessary to use the same end point (less than 10 ppm) and the same analytical method. The average particle size measured by dynamic light scattering of the water-based pigment dispersion is preferably 100 nm or less, and more preferably 80 nm or less, as the same as that of the original water-based dispersion and the modified water-based dispersion. For producing a water-based ink and an ink jet recording liquid, the resulting water-based pigment dispersion may be used as it is, or may be subjected to centrifugation, pressure filtration, vacuum filtration, or the like to remove a small amount of undesired coarse particles.

(Sulfur Content of Sulfonate-Based Polymerizable Surfactant Adsorbed to Pigment)

It is the most important that the content of sulfur of the sulfonate-based polymerizable surfactant adsorbed to the pigment in the water-based pigment dispersion of the invention is at least 15% higher than that in an untreated water-based pigment dispersion (water-based pigment dispersion prepared by ultrafiltering the original water-based dispersion not treated with a peroxodisulfate until the dissolved portion of the sulfonate-based polymerizable surfactant is reduced to less than 10 ppm). In other words, it is important that the sulfur content in the resulting water-based pigment dispersion is more than 1.15 times as high as that in the untreated water-based pigment dispersion. In order to determine the sulfur content, combustion elemental analysis of sulfur is the most preferred in the invention. First, the water-based pigment dispersion and an untreated water-based pigment dispersion as a reference are ultra-centrifuged using a ultra-centrifugal separator. The resulting precipitates are sampled and vacuum-dried. Both dried samples are composed of only the pigment and the adsorbed sulfonate-based polymerizable surfactant. The samples are burned in an oxygen atmosphere to produce only sulfur dioxide gas as a sulfur-containing substance. An apparatus including an infrared detector can determine the sulfur dioxide gas. According to this principle, the content of sulfur of the sulfonate-based polymerizable surfactant adsorbed to the pigment can be determined by combustion elemental analysis.

It is probably based on, but not theoretically constrained by, the following concept of the reactivity that the water-based pigment dispersion of the invention has 15% higher content of sulfur of the sulfonate-based polymerizable surfactant adsorbed to the pigment than the untreated water-based pigment dispersion. Specifically, it has been well known that two persulfate radicals are produced by heating the peroxodisulfate to the decomposition temperature or more and react with various types of substrate before the radicals are quenched. In general, the sulfonate-based surfactant used in the invention does not react with persulfate radicals in a solution. On the other hand, presumably, the sulfonate-based surfactant adsorbed to the pigment is reactive. The adsorption to the pigment may cause polarization to vary the electrophilic and nucleophilic characteristics of the sulfonate-based polymerizable surfactant, thereby producing reactivity different from that in the solution. The different reactivities cause the persulfate radicals to be combined with the sulfonate-based polymerizable surfactant adsorbed to the pigment, or cause the adsorbed sulfonate-based polymerizable surfactant to be bound with the adjacent particles of the surfactant. It is thus supposed that sulfur content in the original dispersoid is increased, or that desorption of sulfur-containing surfactant is reduced by ultrafiltration. Thus, the sulfur content is increased in comparison with the sulfur content in the untreated water-based pigment dispersion.

(Water-Based Ink Composition)

The water-based pigment dispersion of the invention can be used as the original dispersion to produce a water-based ink composition. The water-based ink composition preferably contains 1% to 10% of pigment, and more preferably 2% to 8% of pigment.

The water-based ink composition generally contains an organic solvent in addition to water. For example, preferred organic solvents include water-soluble, water-holding organic solvents, such as glycerin, ethylene glycol, diethylene glycol, triethylene glycol, polyethylene glycol having a molecular weight of 2,000 or less, propylene glycol, dipropylene glycol, tripropylene glycol, 1,3-propylene glycol, isopropylene glycol, isobutylene glycol, 1,4-butanediol, 1,3-butanediol, 1,5-pentanediol, 1,6-hexanediol, meso-erythritol, and pentaerythritol. Among these particularly preferred are glycerin, triethylene glycol, diethylene glycol, and polyethylene glycol having a molecular weight of 2,000 or less.

Particularly preferably, the water-based ink composition contains glycerin from the viewpoint of enhancing the fluidity of the ink in the printer head. The glycerin content relative to the total weight of the ink is preferably in the range of 3% to 20% on a weight basis. A glycerin content of less than 3% degrades the fluidity of the ink in the printer head. A glycerin content of more than 20% tends to increase the viscosity of the ink.

Particularly preferably, the water-based ink composition contains triethylene glycol from the viewpoint of enhancing the fluidity of the ink in the printer head. The triethylene glycol content relative to the total weight of the water-based ink is in the range of 3% to 20%. A triethylene glycol content of less than 3% degrades the fluidity of the ink in the printer head. A triethylene glycol content of more than 20% tends to increase the viscosity of the ink.

Preferably, the water-based ink composition contains a glycol ether and 1,2-alkanediol. When such an ink is printed on a print medium, such as plain paper, ink jet print paper, or ink jet print sheet, both the pigment dispersoid and the aqueous medium do not spread. Accordingly, ooze and nonuniformity in printing can be reduced and thus high quality printing can be achieved.

Examples of the glycol ether include diethylene glycol monoalkyl ether (whose alkyl has a carbon number of 1 to 8), triethylene glycol monoalkyl ether (whose alkyl has a carbon number of 1 to 8), propylene glycol monoalkyl ether (whose alkyl has a carbon number of 1 to 6), and dipropylene glycol monoalkyl ether (whose alkyl has a carbon number of 1 to 6). These glycol ethers may be used singly or in combination.

More specifically, examples of the glycol ether include ethylene glycol monomethyl ether, ethylene glycol monoethyl ether, ethylene glycol monoisopropyl ether, ethylene glycol monobutyl ether, ethylene glycol mono-t-butyl ether, ethylene glycol monomethyl ether acetate, diethylene glycol monomethyl ether (DEGmME), diethylene glycol monoethyl ether (DEGmEE), diethylene glycol monopropyl ether (DEGmPE), diethylene glycol monoisopropyl ether, diethylene glycol monobutyl ether (DEGmBE), diethylene glycol mono-t-butyl ether, diethylene glycol monopentyl ether (DEGmPeE), diethylene glycol monohexyl ether (DEGmHE), diethylene glycol monoheptyl ether (DEGmHpE), diethylene glycol monooctyl ether (DEGmOE), triethylene glycol monomethyl ether (TEGmME), triethylene glycol monoethyl ether (TEGmEE), triethylene glycol monopropyl ether (TEGmPE), triethylene glycol monobutyl ether (TEGmBE), triethylene glycol monopentyl ether (TEGmPeE), triethylene glycol monohexyl ether (TEGmHE), triethylene glycol monoheptyl ether (TEGmHpE), triethylene glycol monooctyl ether (TRGmOE), propylene glycol monomethyl ether (PGmME), propylene glycol monoethyl ether (PGmEE), propylene glycol monopropyl ether (PGmPE), propylene glycol monoisopropyl ether, propylene glycol monobutyl ether (PGmBE), propylene glycol mono-t-butyl ether, propylene glycol monopentyl ether (PGmPeE), propylene glycol monohexyl ether (PGmHE), dipropylene glycol monomethyl ether (DPGmME), dipropylene glycol monoethyl ether (DPGmEE), dipropylene glycol monopropyl ether (DPGmPE), dipropylene glycol monoisopropyl ether, dipropylene glycol monobutyl ether (DPGmBE), dipropylene glycol monopentyl ether (DPGmPeE), and dipropylene glycol monohexyl ether (DPGmHE). As the alkyl group becomes large, the hydrophobicity is increased. The alkyl is preferably selected from among methyl, ethyl, propyl, and butyl, from the viewpoint of enhancing the quality of printing on plain paper.

Among the glycol ethers particularly preferred are diethylene glycol monobutyl ether and triethylene glycol monobutyl ether. Preferably, the water-based ink composition contains 0.5% to 10% of diethylene glycol monobutyl ether and/or triethylene glycol monobutyl ether in total. These glycol ethers in this range help the water-based ink composition exhibit superior permeability. If the content of these glycol ethers is more than 10%, the viscosity is liable to increase.

If the water-based ink composition contains 0.5% by weight or more of at least one compound selected from the group consisting of below-described acetylene glycol surfactants and acetylene alcohol surfactants, the weight ratio of the compound to diethylene and/or triethylene glycol monobutyl ether is preferably in the range of more than 1:0 to 1:10 from the viewpoint of printing quality. Diethylene and triethylene glycol monobutyl ethers can increase the solubility of acetylene glycol surfactants and the printing quality. However, if they are added 10 times or more, their effects cannot be produced as much as expected.

Preferably, the 1,2-alkanediol has a carbon number of 4 to 10. At least two 1,2-alkanediols may be mixed. Examples of 1,2-alkanediol preferably used in the invention include 1,2-butanediol, 1,2-pentanediol, 1,2-hexanediol, and 1,2-heptanediol. These compounds are highly permeable to print media. More preferably, the 1,2-alkanediol is 1,2-hexanediol or 1,2-pentanediol, and most preferably 1,2-hexanediol.

The 1,2-alkanediol content in the water-based ink composition is preferably 20% or less. A 1,2-alkanediol content of more than 20% cannot increase the permeability as much as expected, and tends to reduce the effect of enhancing the printing quality. On the contrary, the viscosity is increased to produce problems. More preferably, the 1,2-alkanediol content is in the range of 0.5% to 15% in the water-based ink composition. At least 0.5% of 1,2-alkanediol can produce sufficient permeability, and 15% or less of 1,2-alkanediol helps adjust the viscosity of the ink to a degree capable of printing by mixing with another additive. Still more preferably, the content is in the range of 1% to 5%.

The water-based ink composition further contains a solubilizing agent, such as 1,3-dimethyl-2-imidazolidine, N-methyl-2-pyrrolidone, or 2-pyrrolidone. Preferably, the solubilizing agent is used when a later-described acetylene alcohol surfactant is used. Particularly preferred is 2-pyrrolidone. The content of the solubilizing agent, such as 2-pyrrolidone, is preferably in the range of 0.5% to 10% in the water-based ink composition. A solubilizing agent content of less than 0.5% cannot produce a sufficient effect, and content of more than 10% tends to increase the viscosity of the ink.

Other components enhancing the solubility of ink components and the permeability to print media such as paper, or preventing the nozzle from being clogged include alkyl alcohols having a carbon number of 1 to 4, such as ethanol, methanol, butanol, propanol, and isopropanol, formamide, acetamide, dimethyl sulfoxide, sorbitol, sorbitan, acetin, diacetin, triacetin, and sulfolane. These compounds may be appropriately selected.

The water-based ink composition may contain polymer particles. The polymer particles may be made of a resin, such as acrylic resin, vinyl acetate-based resin, styrene-butadiene resin, vinyl chloride-based resin, acrylic-styrene resin, butadiene resin, styrene-based resin, silicone resin, urethane resin, polyester resin, polyamide resin, and mixtures of these resins. These resins may be a block copolymer or a random copolymer without particular limitation depending on the form, such as polymer or copolymer. The polymer particles preferably contain a resin essentially composed of an acrylate ester and/or a methacrylate ester. Particularly preferably, the polymer particles contain a resin essentially composed of an acrylate ester and/or a methacrylate ester and styrene.

The polymer particles may have a single-particle structure or a core/shell structure having a core and a shell surrounding the core. The “core shell structure” in the invention refers to a “form in which at least two types of resin having different compositions are present in a phase separated state”. Hence, the shell may cover the entire core or part of the core. The resin constituting the shell partially forms a domain inside the core particle. The polymer particle may have a multilayer structure of at least three layers in such a manner that, for example, at least one layer is formed between the core and the shell.

The polymer particles can be prepared by a known emulsion polymerization. Specifically, an unsaturated vinyl monomer is subjected to emulsion polymerization in water containing a polymerization catalyst and an emulsifier. Examples of the unsaturated vinyl monomer include acrylate ester monomers, methacrylate ester monomers, aromatic vinyl monomers, vinyl ester monomers, vinyl cyanide monomers, halide monomers, olefin monomers and diene monomers, which are generally used for emulsion polymerization. More specifically, such unsaturated vinyl monomers include acrylate esters, such as methyl acrylate, ethyl acrylate, isopropyl acrylate, n-butyl acrylate, isobutyl acrylate, n-amyl acrylate, isoamyl acrylate, n-hexyl acrylate, 2-ethylhexyl acrylate, octyl acrylate, decyl acrylate, dodecyl acrylate, octadecyl acrylate, cyclohexyl acrylate, cyclohexyl acrylate, phenyl acrylate, benzyl acrylate, and glycidyl acrylate; methacrylate esters, such as methyl methacrylate, ethyl methacrylate, isopropyl methacrylate, n-butyl methacrylate, isobutyl methacrylate, n-amyl methacrylate, isoamyl methacrylate, n-hexyl methacrylate, 2-ethylhexyl methacrylate, octyl methacrylate, decyl methacrylate, dodecyl methacrylate, octadecyl methacrylate, cyclohexyl methacrylate, phenyl methacrylate, benzyl methacrylate, and glycidyl methacrylate; vinyl esters, such as vinyl acetate; vinyl cyanides, such as acrylonitrile and methacrylonitrile; halide monomers, such as vinylidene chloride and vinyl chloride; aromatic vinyl monomers, such as styrene, 2-methylstyrene, vinyltoluene, t-butylstyrene, chlorostyrene, vinylanisole, and vinylnaphthalene; olefins, such as ethylene, propylene, and isopropylene; dienes, such as butadiene and chloroprene; and vinyl monomers, such as vinyl ether, vinyl ketone, and vinylpyrrolidone. Monomers having no carboxyl group must be used in combination with an unsaturated vinyl monomer having a carboxyl group. Preferred examples of such unsaturated vinyl monomers include acrylic acid, methacrylic acid, itaconic acid, fumaric acid, and maleic acid. More preferably, methacrylic acid is used. Usable emulsifiers include anionic surfactants, nonionic surfactants, and their mixtures. In addition to sodium lauryl sulfate or potassium lauryl sulfate, anionic surfactants, nonionic surfactants, and amphoteric surfactants can be particularly used, and surfactants that may be added to the above-described ink can be used.

The polymer particles having a core/shell structure can be prepared by a known method, and generally by multistep emulsion polymerization or the like. For example, a method disclosed in Japanese Unexamined Patent Application Publication No. 4-76004 can be applied. Unsaturated vinyl monomers that can be used in polymerization include the above-listed compounds. Preferably, the polymer particles have a structure derived from a sulfonic group and/or sulfonate group. Such polymer particles preferably have a structure formed by crosslinking the structure derived from the sulfonic group and/or sulfonate group and a crosslinkable monomer having at least two polymerizable double bonds. The structure derived from the sulfonic group and/or sulfonate group can be introduced by use of sulfonic group-having monomer as a copolymerizing component. Examples of the monomer having a sulfonic group include vinylsulfonic acid and its salts, styrenesulfonic acid and its salts, 2-(meth)acryloylamino-2-methylpropanesulfonic acid and its salts, and isoprene sulfonate.

Preferably, the water-based ink composition contains a surfactant, particularly an anionic surfactant and/or a nonionic surfactant. Examples of anionic surfactants include sulfonic acid type, such as alkane sulfonates, α-olefin sulfonates, alkylbenzene sulfonates, alkylnaphthalene sulfonates, acylmethyltaurine acid, and dialkylsulfosuccinic acid; alkyl sulfate esters, sulfated oil, sulfated olefin, polyoxyethylenealkyl ether sulfate ester; carboxylic types, such as fatty acid salts and alkyl sarcosinates; phosphate esters, such as alkyl phosphate esters, polyoxyethylene alkyl ether phosphate, and monoglycerite phosphate esters. Examples of nonionic surfactants include ethylene oxide addition type, such as polyoxyethylene alkyl ethers, polyoxyethylene alkylphenyl ethers, polyoxyethylene alkyl esters, and polyoxyethylene alkylamide; polyol esters, such as glycerin alkyl esters, sorbitan alkyl esters, and sugar alkyl esters; polyethers, such as polyhydric alcohol alkyl ethers; and alkanolamides, such as alkanolamine fatty acid amides.

The water-based ink composition preferably contains at least one surfactant selected from the group consisting of acetylene glycol surfactants and acetylene alcohol surfactants. For use of an acetylene glycol surfactant and an acetylene alcohol surfactant, any one of the above-listed glycol ethers is preferably used together. For example, an acetylene glycol-based compound expressed by the following general formula (5) can be used.

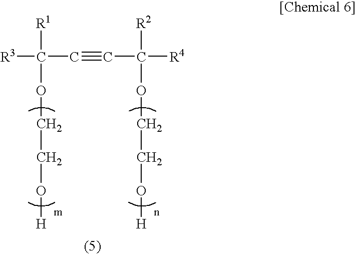

In general formula (5), m and n each represent a number satisfying the relationship 0≦m+n≦50, and R¹, R², R³, and R⁴ are each an alkyl group (preferably having a carbon number of 6 or less). Among the compounds expressed by general formula (5), particularly preferred are 2,4,7,9-tetramethyl-5-decyne-4,7-diol, 3,6-dimethyl-4-octyne-3,6-diol, and 3,5-dimethyl-1-hexyne-3-ol. A commercially available acetylene glycol surfactant may be used as the compound expressed by general formula (5). Examples of such compounds include SURFYNOLs 104, 104-PG50, 82, 440, 465, 485, and STG (each available from Air Products and Chemicals Inc.) and OLFINE STG and OLFINE E1010 (each product name, produced by Nissin Chemical Industry).

Acetylene alcohol surfactants may be used, such as OLFINE P and OLFINE B (each produced by Nissin Chemical Industry) and SURFYNOL 61 (produced by Air Products). In use of an acetylene alcohol surfactant, a solubilizing agent may be used together. Preferred solubilizing agents include dimethyl-2-imidazolidinone, 2-pyrrolidone, and N-methyl-2-pyrrolidone. Polysiloxane surfactants may be used, such as BYK-301, 302, 307, 325, 331, 341, 345, 346, 347, 348, and 375 (produced by BYK).

The surfactant content in the water-based ink composition is preferably in the range of 0.01% to 10%, more preferably 0.1% to 5%, and still more preferably 0.1% to 2%.

In order to control the permeability to print media, another surfactant may be added to the water-based ink composition. If added, a surfactant compatible with the ink composition, particularly a permeable, stable surfactant, is suitable. Such a surfactant may be an amphoteric surfactant or a nonionic surfactant. Amphoteric surfactants include betaine lauryldimethylaminoacetate, 2-alkyl-N-carboxymethyl-N-hydroxyethylimidazolinium betaine, betaine coconut oil fatty acid amidopropyldimethylaminoacetate, polyoctylpolyaminoethylglycine, and imidazoline derivatives. Nonionic surfactants include ethers, such as polyoxyethylene nonylphenyl ether, polyoxyethylene octylphenyl ether, polyoxyethylene dodecylphenyl ether, polyoxyethylene alkylallyl ether, polyoxyethylene oleyl ether, polyoxy ethylene lauryl ether, polyoxy ethylene alkyl ether, and polyoxyalkylene alkyl ether; esters, such as polyoxyethylene oleate, polyoxyethylene distearate, sorbitan laurate, sorbitan monostearate, sorbitan monoolate, sorbitan sesquiolate, polyoxyethylene monoolate, polyoxyethylene stearate; and fluorine-containing surfactants, such as fluoroalkyl esters and perfluoroalkyl carboxylates.

In addition, trimethylolpropane is preferably added as a solid wetting agent.

The water-based ink composition may further contain a pH adjuster; an amine or its conversion product, such as diethanolamine, triethanolamine, propanolamine, or morpholine; an inorganic hydroxide, such as potassium hydroxide, sodium hydroxide, or lithium hydroxide; ammonium hydroxide or a quarternary ammonium salt such as tetramethyl ammonium; a carbonate, such as potassium carbonate, sodium carbonate, or lithium carbonate; or a phosphate.

Other additives may be used, including urea, thiourea, tetramethyl urea and other urea compounds; allophanates such as methyl allophanate and other allophanate compounds; biuret, dimethyl biuret, tetramethyl biuret and other biuret compounds; L-ascorbic acid and its salts; and commercially available antioxidants and UV absorbers.

The water-based ink composition preferably has a surface tension of 45 mN/m or less, and more preferably in the range of 20 to 45 mN/m. A surface tension of more than 45 mN/m leads to problems, such as degrading the drying properties of printing, easily causing ooze, and causing color bleed, and accordingly makes it difficult to produce favorable printed images. An ink having a surface tension of less than 20 mN/m is liable to wet the surroundings of the nozzles of the printer head and often causes problems in ejection stability of, for example, ejecting ink in a wrong direction. The surface tension can be measured with an ordinary surface tension meter. The surface tension of ink can be set in the above range by adjusting the type of ink components and their proportions. Preferably, coarse particles are removed from the water-based ink composition by filtration through, for example, a metallic mesh filter or a membrane filter. Filtration may be performed while a pressure is applied to the water-based ink composition or while the pressure at the reception end of the filtering device is reduced. Preferably, excessively large particles may be removed by centrifugation before filtration.

(Properties of Water-Based Pigment Dispersion and Water-Based Ink)

As described above, the water-based ink composition prepared from the water-based pigment dispersion of the invention is suitable for use in ink jet recording apparatuses. When the water-based ink composition is used for ink jet recording liquid, it can enhance the long-term storage stability (clogging resistance) in the printer head nozzles, and can maintain superior ejection stability. In addition, maintenance work for the head can be reduced.

Examples of the invention will now be described. The following Examples are intended to describe the invention in detail, but the invention is limited to the Examples.

### EXAMPLES

Preparation of Water-Based Pigment Dispersion M

In 850 g of ion exchanged water was dissolved 50 g of sulfonate-based polymerizable surfactant AQUALON KH-10 (produced by Dai-ich Kogyo Seiyaku). To this solution was added and mixed 100 g of 2,9-dimethylquinacridone pigment (C. I. Pigment Red 122). The mixture was dispersed to prepare a water-based dispersion under conditions of a bead packing rate of 70% and a rotational speed of 5,000 rpm for 5 hours using a disperser Eiger Motor Mill model M250 (product name, manufactured by Eiger Japan). After dispersion, the resulting mixture was subjected to ultrafiltration with a Millipore Pellicon Mini System including a single PES plate having pores of a 300 kilodalton grade on a molecular weight basis. The ultrafiltration was performed by a cross-flow method until the AQUALON KH-10/pigment ratio becomes 40/100 (derived from the concentrations of solid content and pigment). Thus, a water-based dispersion containing 15% by weight of solid was prepared. The resulting water-based dispersion was placed in a reactor equipped with a stirrer, a reflux condenser, a dropping funnel, a heat regulator, and a nitrogen inlet tube, and the temperature in the reactor was increased to 80° C. A solution prepared by dissolving 1.2 g of ammonium peroxodisulfate in 100 g of ion exchanged water was dripped over 1 hour, and the water-based dispersion was treated at a constant temperature of 80° C. for 3 hours in the reactor while nitrogen is introduced to the reactor. After the treatment and cooling to room temperature, the pH of the resulting modified water-based dispersion was adjusted to 8 with an ammonia solution (20%), and subsequently, coarse particles were removed by filtration through a membrane filter with a pore size of 3 μm. Then, the modified water-based dispersion was subjected to ultrafiltration by a cross flow method using an ultrafiltration apparatus (the same system as above). In the ultrafiltration, a solution containing 1% of ammonia was added to the modified water-based dispersion to be filtered to maintain the volume of the dispersion to be filtered while the filtrate was collected. For each time when 20 L of filtrate was collected, 3 mL of aliquot was sampled from the dispersion to be filtered and subjected to ultracentrifugation (at 80,000 rpm, for 2 hours). Colorless supernatant was sampled, and the dissolved portion of AQUALON KH-10 was analyzed with a refractive index detector connected to a high-performance liquid chromatography apparatus, using the following equipment: (1) L-6000 pump (Hitachi Koki), (2) Oven model 556 (Gaschro Kogyo), (3) Shodex RI SE-52 differential refractive index detector (Showa Denko), and (4) D520 GPC Integrator (Hitachi Koki). Two columns, TSK gel G6000PW (Tosoh Corporation), of 7.5 mm in diameter by 30 cm in length were connected in series. The eluent was a mixture (about pH 9.25) of 0.025 M sodium tetraborate decahydrate and 0.0018 M sodium hydroxide, and was used at a flow rate of 0.8 mL/minute. The sample volume was 100 μL. Using a standard curve prepared from pure water and AQUALON KH-10 solutions (5 ppm, 10 ppm, 20 ppm, 50 ppm), aliquots were analyzed. When the concentration of dissolved AQUALON KH-10 in an aliquot was reduced to less than 10 ppm, the filtration object was stopped to be supplied and concentrated. Thus, 80 L of filtrate was collected and the concentration was reduced to less than 10 ppm. The filtrate was concentrated so that the solid content was about 10% by weight to yield the water-based pigment dispersion. The average particle size of the dispersoid in the water-based pigment dispersion was measured with a laser Doppler-type particle size distribution analyzer MICROTRACK UPA150 (product name, manufactured by Leeds and Northrop) and was, as a result, 65 nm. The resulting dispersion was vacuum dried at room temperature to yield solid matter. The solid matter was subjected to combustion elemental sulfur analysis to obtain the content of sulfur of the sulfonate-based polymerizable surfactant adsorbed to the pigment. The elemental sulfur analysis was performed with an elemental analyzer EMIA820V (produce name, manufactured by Horiba Jobin Yvon). The sulfur content in the solid matter was 0.43%.

(2) Preparation of Water-Based Pigment Dispersion Y

A water-based dispersion was prepared in the same manner as in the preparation of water-based pigment dispersion M, except that 100 g of 2-(2-methoxy-4-nitrophenyl)azo N-(2-methoxyphenyl)-3-oxobutaneamide pigment (C. I. Pigment Yellow 74) was used as the pigment. The product was used as water-based pigment dispersion Y. The average particle size of the dispersoid in the water-based pigment dispersion was measured with a laser Doppler-type particle size distribution analyzer MICROTRACK UPA150 (product name, manufactured by Leeds and Northrop) and was, as a result, 87 nm. Elemental sulfur analysis was performed with an elemental analyzer EMIA820V (produce name, manufactured by Horiba Jobin Yvon), and the sulfur content in the resulting solid matter was 0.40%.

(3) Preparation of Water-Based Pigment Dispersion C

A water-based dispersion was prepared in the same manner as in the preparation of water-based pigment dispersion M, except that 100 g of copper phthalocyanine pigment (C. I. Pigment Blue 15:4) was used as the pigment. The product was used as water-based pigment dispersion C. The average particle size of the dispersoid in the water-based pigment dispersion was measured with a laser Doppler-type particle size distribution analyzer MICROTRACK UPA150 (product name, manufactured by Leeds and Northrop) and was, as a result, 45 nm. Elemental sulfur analysis was performed with an elemental analyzer EMIA820V (produce name, manufactured by Horiba Jobin Yvon), and the sulfur content in the resulting solid matter was 0.51%.

(4) Preparation of Water-Based Dispersion M Containing Less Than 10 ppm of Dissolved Portion (Comparative Example)

In 850 g of ion exchanged water was dissolved 50 g of sulfonate-based polymerizable surfactant AQUALON KH-10 (produced by Dai-ich Kogyo Seiyaku), and 100 g of 2,9-dimethylquinacridone pigment (C. I. Pigment Red 122) was added to the solution. The mixture was dispersed to prepare a water-based dispersion under conditions of a bead packing rate of 70% and a rotational speed of 5,000 rpm for 5 hours using a disperser Eiger Motor Mill model M250 (product name, manufactured by Eiger Japan). After dispersion, the resulting water-based dispersion was placed in a reactor equipped with a stirrer, a reflux condenser, a heat regulator, and a nitrogen inlet tube. The temperature in the reactor was increased to 80° C. and the water-based dispersion was treated at a constant temperature of 80° C. for 3 hours. After the treatment and cooling to room temperature, the pH of the water-based dispersion was adjusted to 8 with an ammonia solution (20%), and subsequently, coarse particles were removed by filtration through a membrane filter with a pore size of 3 μm. Then, the water-based dispersion was subjected to ultrafiltration by a cross flow method using Millipore Pellicon Mini System including a single PES plate having pores of a 300 kilodalton grade on a molecular weight basis. In this ultrafiltration, a solution containing 1% of ammonia was added to the water-based dispersion to be filtered to maintain the volume of the dispersion to be filtered while the filtrate was collected. For each time when 20 L of filtrate was collected, 3 mL of aliquot was sampled from the dispersion to be filtered and subjected to ultracentrifugation (at 80,000 rpm for 2 hours). Colorless supernatant was sampled, and dissolved AQUALON KH-10 was analyzed with a refractive index detector connected to a high-performance liquid chromatography apparatus. The analysis was performed by the same method as in the preparation of water-based pigment dispersion M. When the concentration of dissolved AQUALON KH-10 in an aliquot was reduced to less than 10 ppm, the dispersion to be filtered was stopped to be supplied and concentrated. Thus, 80 L of filtrate was collected and the concentration was reduced to less than 10 ppm. The filtrate was concentrated so that the solid content was about 10% by weight to yield a comparative water-based pigment dispersion. The average particle size of the dispersoid in the water-based dispersion was measured with a laser Doppler-type particle size distribution analyzer MICROTRACK UPA150 (product name, manufactured by Leeds and Northrop) and was, as a result, 63 nm. The resulting dispersion was vacuum dried at room temperature to yield solid matter. The solid matter was subjected to combustion elemental sulfur analysis to obtain the sulfur content of the sulfonate-based polymerizable surfactant adsorbed to the pigment. The elemental sulfur analysis was performed with an elemental analyzer EMIA820V (produce name, manufactured by Horiba Jobin Yvon). The sulfur content in the solid matter was 0.35%.

(5) Preparation of Water-Based Dispersion Y Containing Less Than 10 ppm of Dissolved Portion (Comparative Example)

A comparative water-based dispersion was prepared in the same manner as in the preparation of water-based dispersion M containing less than 10 ppm of dissolved portion, except that 100 g of 2-(2-methoxy-4-nitrophenyl)azo N-(2-methoxyphenyl)-3-oxobutaneamide pigment (C. I. Pigment Yellow 74) was used as the pigment. The product was used as water-based dispersion Y containing less than 10 ppm of dissolved portion. The average particle size of the dispersoid in the water-based dispersion was measured with a laser Doppler-type particle size distribution analyzer MICROTRACK UPA150 (product name, manufactured by Leeds and Northrop) and was, as a result, 93 nm. Elemental sulfur analysis was performed with an elemental analyzer EMIA820V (produce name, manufactured by Horiba Jobin Yvon). The sulfur content in the solid matter was 0.31%.

(6) Preparation of Water-Based Dispersion C Containing Less Than 10 ppm of Dissolved Portion (Comparative Example)

A comparative water-based dispersion was prepared in the same manner as in the preparation of water-based dispersion M containing less than 10 ppm of dissolved portion, except that 100 g of copper phthalocyanine pigment (C. I. Pigment Blue 15:4) was used as the pigment. The product was used as water-based dispersion C containing less than 10 ppm of dissolved portion. The average particle size of the dispersoid in the water-based dispersion was measured with a laser Doppler-type particle size distribution analyzer MICROTRACK UPA150 (product name, manufactured by Leeds and Northrop) and was, as a result, 51 nm. Elemental sulfur analysis was performed with an elemental analyzer EMIA820V (produce name, manufactured by Horiba Jobin Yvon). The sulfur content in the solid matter was 0.43%.

Table 1 shows all results of the elemental sulfur analysis of Examples (M, Y, and C) and Comparative Examples (M, Y, and C).

TABLE 1
Evaluation results

| | Pigment color | | |
|---|---|---|---|
| Item | M | Y | C |
| Sulfur content in Example | 0.43 | 0.40 | 0.51 |
| Sulfur content in Comparative Example | 0.35 | 0.31 | 0.43 |
| Increase in sulfur content | 22.9 | 29.0 | 18.6 |
| (Example vs. Comparative Example, %) | | | |

Table 1 shows that the sulfur content in Example water-based pigment dispersion M was 15% or more increased in comparison with the sulfur content in Comparative water-based dispersion M (untreated water-based pigment dispersion obtained by subjecting the water-based dispersion not treated with a peroxodisulfate to ultrafiltration until the dissolved portion of the sulfonate-based polymerizable surfactant in the aqueous medium was reduced to less than 10 ppm). Similarly, it is shown that the sulfur content in Example water-based pigment dispersion Y was 15% or more increased in comparison with the sulfur content in Comparative water-based dispersion Y, and that the sulfur content in Example water-based pigment dispersion C was 15% or more increased in comparison with the sulfur content in Comparative water-based dispersion C.

(Preparation of Water-Based Ink)

### Example 1

A mixture of 50.0 g of water-based pigment dispersion M prepared as above, acetylene glycol: 0.1 g of SURFYNOL 104PG-50 and 0.4 g of SURFYNOL 465 (both being product names, produced by Air Products and Chemicals Inc.), 2 g of trimethylolpropane, and organic solvents: 14 g of glycerin; 4 g of 2-pyrrolidone; 2 g of triethylene glycol; 1 g of triethylene glycol monobutyl ether; and 2.5 g of 1,2-hexanediol was prepared, and ultrapure water was added until the total weight becomes 100 g. The resulting mixture was stirred for 2 hours and filtered through a membrane filter (product name, produced by Nihon Millipore) with a pore size of about 1.2 μm to yield water-based ink composition of Example 1.

### Examples 2 to 9

Water-based ink compositions of Examples 2 to 9 were prepared using water-based pigment dispersion M, Y, or C according to the compositions shown in Table 2 in the same manner as in Example 1.

TABLE 2

| | Example | | | | | | | | |
|---|---|---|---|---|---|---|---|---|---|
| Example | 1 | 2 | 3 | 4 | 5 | 6 | 7 | 8 | 9 |
| Water-based pigment dispersion | M | M | M | Y | Y | Y | C | C | C |
| Composition | Content (wt %) | | | | | | | | |
| Dispersion | 50 | 50 | 50 | 48 | 48 | 48 | 37 | 37 | 37 |
| Glycerin | 14 | 12 | 10 | 15 | 13 | 10 | 19 | 14 | 12 |
| 2-Pyrrolidone | 4 | 4 | 4 | 4 | 4 | 4 | 4 | 2.5 | 2.5 |
| Triethylene glycol | 2 | 2 | 2 | 2 | 2 | 2 | 2 | 2 | 2 |
| Triethylene glycol monobutyl ether | 1 | 2 | — | 1 | 2 | — | 1 | 2 | — |
| Diethylene glycol monobutyl ether | — | — | 2.5 | — | — | 2.5 | — | — | 2.5 |
| 1,2-Hexanediol | 2.5 | 5 | 7.5 | 2.5 | 5 | 7.5 | 2.5 | 5 | 7.5 |
| Triethanolamine | — | — | — | — | — | — | — | 0.5 | 0.5 |
| SURFYNOL 104PG-50 | 0.1 | 0.1 | 0.1 | 0.1 | 0.1 | 0.1 | 0.1 | 0.1 | 0.1 |
| SURFYNOL 465 | 0.4 | 0.4 | 0.4 | 0.4 | 0.4 | 0.4 | 0.4 | 0.4 | 0.4 |
| Ultrapure water | Balance | Balance | Balance | Balance | Balance | Balance | Balance | Balance | Balance |

### Comparative Examples 1 to 9

Water-based ink compositions of Comparative Examples 1 to 9 were prepared using Comparative water-based dispersion (untreated water-based pigment dispersion) M, Y, or C containing less than 10 ppm of dissolved portion, according to the compositions shown in Table 3 in the same manner as in Example 1.

TABLE 3

| | Comparative Example | | | | | | | | |
|---|---|---|---|---|---|---|---|---|---|
| Example | 1 | 2 | 3 | 4 | 5 | 6 | 7 | 8 | 9 |
| Water-based pigment dispersion | | | | | | | | | |
| containing less than 10 ppm of | | | | | | | | | |
| dissolved portion | M | M | M | Y | Y | Y | C | C | C |
| Composition | Content (wt %) | | | | | | | | |
| Dispersion | 49.5 | 49.5 | 49.5 | 48 | 48 | 48 | 37.1 | 37.1 | 37.1 |
| Glycerin | 14 | 12 | 10 | 15 | 13 | 10 | 19 | 14 | 12 |
| 2-Pyrrolidone | 4 | 4 | 4 | 4 | 4 | 4 | 4 | 2.5 | 2.5 |
| Triethylene glycol | 2 | 2 | 2 | 2 | 2 | 2 | 2 | 2 | 2 |
| Triethylene glycol monobutyl ether | 1 | 2 | — | 1 | 2 | — | 1 | 2 | — |
| Diethylene glycol monobutyl ether | — | — | 2.5 | — | — | 2.5 | — | — | 2.5 |
| 1,2-Hexanediol | 2.5 | 5 | 7.5 | 2.5 | 5 | 7.5 | 2.5 | 5 | 7.5 |
| Triethanolamine | — | — | — | — | — | — | — | 0.5 | 0.5 |
| SURFYNOL 104PG-50 | 0.1 | 0.1 | 0.1 | 0.1 | 0.1 | 0.1 | 0.1 | 0.1 | 0.1 |
| SURFYNOL 465 | 0.4 | 0.4 | 0.4 | 0.4 | 0.4 | 0.4 | 0.4 | 0.4 | 0.4 |
| Ultrapure water | Balance | Balance | Balance | Balance | Balance | Balance | Balance | Balance | Balance |

(Evaluation of Water-Based Ink Compositions)

(Ejection Stability)

Water-based ink compositions of Examples 1 to 9 and Comparative Examples 1 to 9 were introduced to an ink jet printer PX-V700 (product name, manufactured by Seiko Epson) separately. An image including letters and solid areas was continuously printed on sheets (Xerox 4024) under the conditions of 25° C. and 40% RH. Evaluation was performed by visually checking for a problem, such as ejection in a wrong direction or a missing point every 250 sheets. The evaluation was continued up to 5,000 sheets. The evaluation criteria were as follows:

Evaluations A: No problems, such as ejection in a wrong direction or missing point, occurred up to 5,000 sheets.

B: No problems occurred up to 4,000 sheets, but ejected ink was deviated in a wrong direction or a point was missed between 4,000 sheets and less than 5,000 sheets.

C: No problems occurred up to 3,000 sheets, but ejected ink was deviated in a wrong direction or a point was missed between 3,000 sheets and less than 4,000 sheets.

D: No problems occurred up to 2,000 sheets, but ejected ink was deviated in a wrong direction or a point was missed between 2,000 sheets and less than 3,000 sheets.

F: No problems occurred up to 1,000 sheets, but ejected ink was deviated in a wrong direction or a point was missed between 1,000 sheets and less than 2,000 sheets.

(Mark A means that the ink composition has ejection stability.) The results are all shown in Table 4.

TABLE 4

| | Ejection | Storage | Clogging |
|---|---|---|---|
| Evaluation | stability | stability | resistance |
| Example 1 | A | A | A |
| Example 2 | A | A | B |
| Example 3 | A | A | B |
| Example 4 | A | A | A |
| Example 5 | A | A | A |
| Example 6 | A | A | B |
| Example 7 | A | A | A |
| Example 8 | A | A | A |
| Example 9 | A | A | A |
| Comparative Example 1 | D | F | F |
| Comparative Example 2 | D | F | F |
| Comparative Example 3 | F | F | F |
| Comparative Example 4 | B | D | D |
| Comparative Example 5 | C | D | D |
| Comparative Example 6 | D | F | F |
| Comparative Example 7 | B | B | C |
| Comparative Example 8 | B | B | C |
| Comparative Example 9 | D | C | D |

(Storage Stability)

Water-based ink compositions of Examples 1 to 9 and Comparative Examples 1 to 9 were allowed to stand at 60° C. for two weeks and for a month, and in a frozen state for a week, and their viscosities after the tests were compared with the viscosities immediately after they were prepared. The evaluation criteria were as follows:

Evaluations A: Variation of less than ±6%

B: Variation of ±6% or more and less than ±10%

C: Variation of ±10% or more and less than ±15%

D: Variation of ±15% or more and less than ±25%

F: Variation of ±25% or more

(Mark A means that the ink composition has storage stability.) The results are all shown in Table 4. The viscosities for evaluation were measured at 20° C. with a viscometer Digital Viscomate VM-100A (manufactured by Yamaichi Electronics).

(Clogging Resistance)

Clogging resistances of the water-based ink compositions of Examples 1 to 9 and Comparative Examples 1 to 9 were evaluated as below. Each ink composition was deaerated and placed in a heat-sealable aluminum package and sealed. Then, the water-based ink composition was introduced to an ink jet printer Stylus C80 (product name, manufactured by Seiko Epson). A line pattern formed using all the nozzles was first printed and the water-based ink composition was adjusted so as to be ejected in appropriate directions from all nozzles. Then, the ink cartridge was removed from the printer head and further the printer head was removed from the printer.

The printer head without a cap was allowed to stand in a constant temperature unit of 40° C. for 6 days. Then, the printer head was installed to the printer and the ink cartridge was installed to the printer head. After a line pattern formed using all nozzles was printed, cleaning was performed. After cleaning, line patterns were printed until all nozzles ejected the ink in appropriate directions to draw correct lines. The evaluation criteria were as follows:

Evaluations A: On sending a printing signal to the printer, appropriate printing was performed without cleaning.

B: After cleaning twice or less, appropriate printing was performed.

C: After cleaning four times or less, appropriate printing was performed.

D: After cleaning 6 times or less, appropriate printing was performed.

F: Even after cleaning seven times or more, inappropriate printing was performed.

(Marks A and B mean that the ink composition has clogging resistance.) The results are all shown in Table 4.

Table 4 shows that all the ink compositions of Examples 1 to 9 were evaluated as A in ejection stability and long-term storage stability (in terms of changes in viscosity), exhibiting satisfying results. The ink compositions of Examples 1 to 9 were also evaluated as A or B in clogging resistance, exhibiting satisfying results. On the other hand, the ink compositions of Comparative Examples 1 to 9 did not exhibit ejection stability, long-term storage stability, or clogging resistance.

1. A water-based pigment dispersion comprising: a pigment dispersoid containing a pigment and a sulfonate-based polymerizable surfactant adsorbed to the pigment,
wherein the water-based pigment dispersion is produced by a process including the steps of pulverizing and mixing a mixture containing the pigment, the sulfonate-based polymerizable surfactant, and an aqueous medium to prepare a water-based dispersion; treating the water-based dispersion in the presence of a peroxodisulfate to prepare a modified water-based dispersion; and subjecting the modified water-based dispersion to ultrafiltration until the concentration of the dissolved portion of the sulfonate-based polymerizable surfactant in the aqueous medium is reduced to less than 10 ppm.

2. The water-based pigment dispersion according to claim 1, wherein the sulfonate-based polymerizable surfactant is a compound expressed by general formula (1): 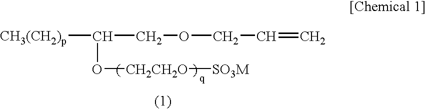
(In the above formula, p represents a number of 9 or 11, q represents a number in the range of 2 to 20, and M represents an alkali metal atom, ammonium, or protonated alkanolamine.)

3. The water-based pigment dispersion according to claim 1, wherein the compound expressed by general formula (1) is a mixture of a compound having p of 9, q of 10, and M of ammonium and a compound having p of 11, q of 10, and M of ammonium.

4. The water-based pigment dispersion according to claim 1, wherein the peroxodisulfate is at least one compound selected from the group consisting of sodium peroxodisulfate, potassium peroxodisulfate, and ammonium peroxodisulfate.

5. The water-based pigment dispersion according to claim 1, wherein the content of sulfur of the sulfonate-based polymerizable surfactant adsorbed to the pigment is at least 15% higher than that in an untreated water-based pigment dispersion obtained by ultrafiltering the water-based dispersion not treated with the peroxodisulfate until the dissolved portion of the sulfonate-based polymerizable surfactant in the aqueous medium is reduced to less than 10 ppm.

6. The water-based pigment dispersion according to claim 1, wherein the pigment dispersoid has an average particle size of 100 nm or less.

7. A water-based ink comprising the water-based pigment dispersion as set forth in claim 1.

8. An ink jet recording liquid comprising the water-based pigment dispersion as set forth claim 1.
